(19) United States
(12) Patent Application Publication
(10) Pub. No.: US 2013/0052956 A1
(43) Pub. Date: Feb. 28, 2013

(54) Hand-Held Mobile Device Dock

(71) Applicant: James W. McKell, Smyrna, GA (US)

(72) Inventor: James W. McKell, Smyrna, GA (US)

(21) Appl. No.: 13/592,227

(22) Filed: Aug. 22, 2012

Related U.S. Application Data
(60) Provisional application No. 61/552,513, filed on Oct. 28, 2011.
(60) Provisional application No. 61/526,232, filed on Aug. 22, 2011.

(51) Int. Cl. A45C 15/00; A45C 11/00; H04R 1/02; G06F 1/16

(52) U.S. Cl. 455/41.2; 361/679.41; 206/37; 381/91; 381/332

(57) ABSTRACT

A mobile device dock is provided. The dock is a hand-held mobile device that receives a mobile phone, tablet, or other mobile device. The dock improves a user's grip of a mobile device, allows for hands-free use of the mobile device, and/or may improve sound quality of the mobile device.

### CROSS REFERENCE TO RELATED APPLICATIONS

This U.S. non-provisional application claims priority from U.S. provisional patent No. 61/526,232 entitled HAND-HELD MOBILE PHONE DOCK, filed Aug. 22, 2011 and U.S. provisional patent No. 61/552,513 entitled HAND-HELD MOBILE PHONE DOCK, filed Oct. 28, 2011, the disclosures of both are incorporated by reference herein in their entirety.

### TECHNICAL FIELD

This application relates generally to mobile device accessories, and particularly to accessories adapted to portable, wireless or mobile devices. In one aspect, an embodiment serving as an accessory for a mobile phone that improves ease of handling and sound quality is presented.

### BACKGROUND

More and more people are using mobile, telephones instead of landline telephones for communication. As these devices become smaller, they are more difficult to handle, particularly for the young, elderly, or handicapped such as those with arthritis. They are also difficult to use hands-free.

In addition, the smaller size of mobile phones and devices compromises sound quality. Landline handsets provide better sound by incorporating, larger and more efficient transducers in an enclosure designed for acoustic enhancement. Many mobile phone users feel the need to speak louder than necessary because they cannot hear their own voice through the earpiece.

### SUMMARY

Therefore, it would be useful to have a hand-held dock to more easily grip, handle and use the mobile device hands-free, and to improve the sound quality.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 Illustrates difficulty of holding a mobile phone

FIG. 2 Illustrates mobile phone dock in use

FIG. 3 Illustrates one embodiment of dock

FIG. 4 Illustrates an embodiment of dock with mobile phone installed

FIG. 5 Illustrates side view of embodiment depicted in FIG. 4

FIG. 6 Illustrates side view of embodiment depicted in FIGS. 4 and 5 with mobile phone installed

FIG. 7 Illustrates another embodiment of dock

FIG. 8 Illustrates an embodiment of dock with mobile phone installed

FIG. 9 Illustrates side view of the embodiment depicted in FIG. 8

FIG. 10 Illustrates side view of the embodiment depicted in FIG. 8 and FIG. 9 with mobile phone installed

FIG. 11 Illustrates an embodiment of dock in charger

FIG. 12 Illustrates hand-held embodiment of dock with stereophonic loudspeakers

FIG. 13 Illustrates an embodiment comprising a slot on back of dock

FIG. 14 Illustrates the embodiment depicted in FIG. 13 with mobile phone installed

FIG. 15 Illustrates an embodiment of dock in use with optional strap and stereo playback

FIG. 16 shows front view of folding model

FIG. 17 shows side view of folding model in open position

FIG. 18 shows side view of folding model in closed position

### DETAILED DESCRIPTION

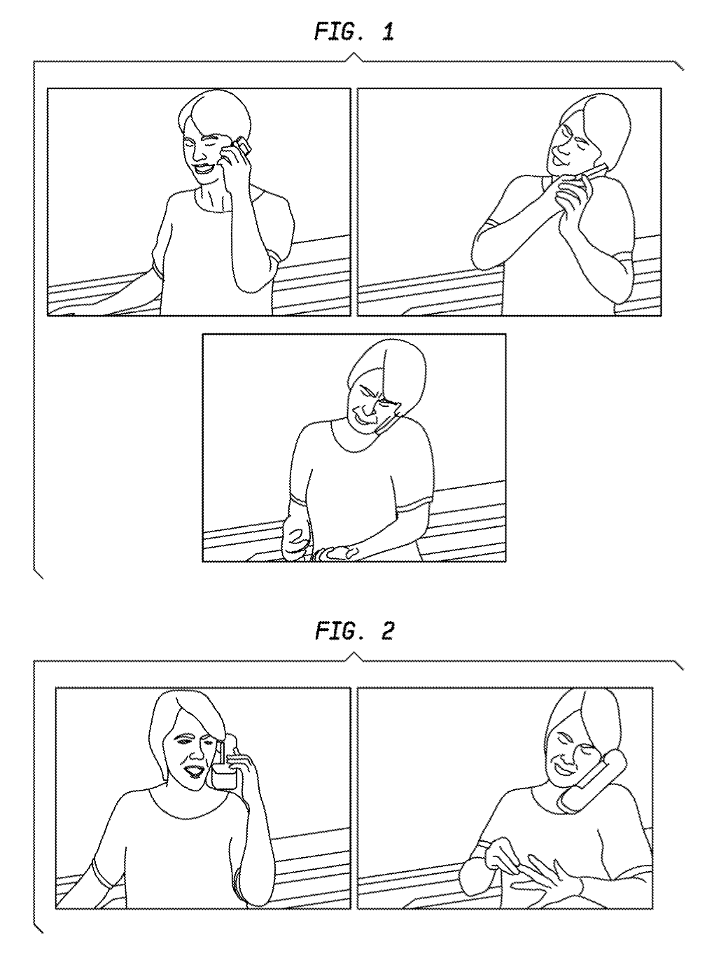

Referring to FIG. 1, a mobile phone user finds it difficult to hold the mobile phone to the ear without using at least one hand. As used herein the term mobile device, mobile phone, or the like refers generally to a portable, or wireless communications device, including without limitation a cordless phone, a cellular phone, or a mobile.

Referring to FIG. 2, mobile phone user is able to more easily hold the mobile phone with one hand or hands-free with the dock employed, comfortably pinching the dock between the ear, chin, and shoulder. Therefore, the dock is said to be adapted to be handheld. In one example, the dock has an earpiece cup and a mouthpiece cup, wherein the distance between the center of the earpiece cup and the center of the mouthpiece cup is about 6 inches. In another embodiment, the distance between the center of the earpiece cup and the center of the mouthpiece cup may be about 4 inches to about 8 inches. The sizing, and soft compressible material of the dock minimize pressure necessary to hold the phone, while keeping the neck straighter. In another embodiment, the dock is configured to more easily hold another mobile device, for example, a smart pad or the like.

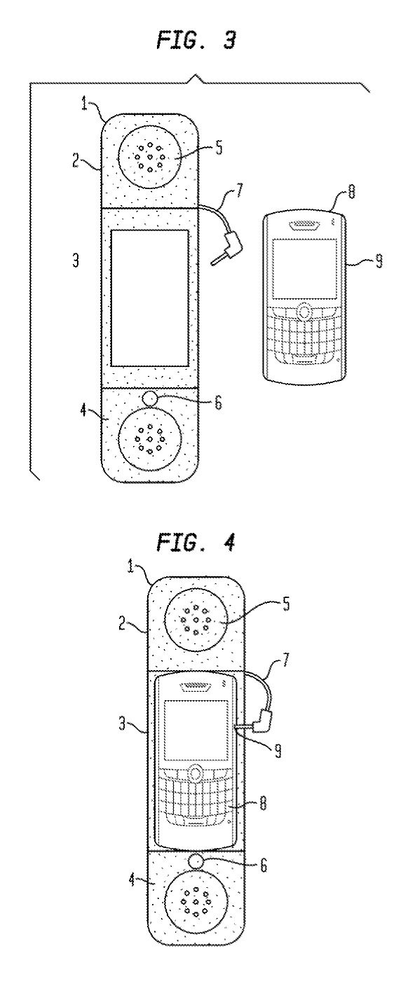

Referring to FIGS. 3, 4, 5, 6, a dock 1 shown in use in FIG. 2 is depicted. In certain embodiments, the dock 1 is constructed from high-density foam rubber. In alternative embodiments dock 1 is constructed from various materials including materials of differing material properties and/or composite materials as known to those of ordinary skill to achieve the desired functionality. Slot, cavity, or receptacle 3 is provided to accept mobile phone 8. In other words, the dock 1 is configured to include a slot or the like to releasably and/or securably receive a mobile phone 8 (for example) of a conventional size, where the slot 3 of dock 1 is configured to be about the same size or larger in size (length, height, and/or width) than the conventional size (respective length, height, and or width) of the mobile phone. Therefore, the dock 1 protects the mobile phone and provides for a mobile docked device that is more easily held, in one embodiment, the thickness of the dock 1 from front TO back is about 0.50 inch to about 1.0 inch thick. In yet another embodiment, the thickness of the dock 1 from front to back is about 0.50 inch to about 2.0 inches thick. In another embodiment, the thickness of the dock from front to back is about 1.0 inch to about 4.0 inches thick. In another embodiment, the thickness of the dock 1 from front to back is about 2.0 inches to about 4.0 inches thick. In one example, upon insertion of mobile phone 8 into slot 3, the foam, rubber, or similar material of at least a portion of dock 1 is compressed and therefore holds the phone securely. Dock 1 is functional without any further enhancements, providing assistance to hands-free operation of the mobile phone (FIG. 2), cushioning from falls and easier gripping (FIG. 12). Foam rubber construction makes the dock 1 lighter than the mobile phone 8. In an alternative embodiment, the slot 3 further comprises a separate plastic insert that has an outer form adapted to fit into the slot 3 and an inner form adapted to accept the mobile phone 8. And in still another embodiment, the slot 3 further comprises a stiffener or reinforcement that is affixed or formed with the foam rubber that runs along the length of the slot adapted to provide a stiffer receptacle for the mobile phone 8. In another example, dock 1 may securably hold mobile phone 8 by a means that includes at least one of the following: an interference, fit between mobile phone 8 and dock 1, a spring loaded mechanism, a releasable clip, and a magnetic release assembly.

In one embodiment, dock 1 includes earpiece 2 and mouthpiece 4. Both are formed in the shape of a cup, which improves low frequency response and reduces background noise. In another embodiment, the dock includes as passive audio coupling that transfers pressure waves created by the speaker of the mobile device to the earpiece of the dock, i.e., the earpiece is operably coupled to the phone via, a passive audio coupling. In yet another embodiment, the dock includes a passive audio coupling that transfers pressure waves created by a user of the mobile device, transferring them through an audio port and/or the audio channel to the mouthpiece of the dock, i.e., the mouthpiece is operably coupled to the phone via a passive audio coupling. The microphone and speaker audio ports in combination and separately are referred to as passive audio ports. The passive audio coupling is not an electronic means for transferring a signal, rather it is a passive audio coupling. In another embodiment, the dock includes a shaped channel extending from the slot to the earpiece cup, shaped to modulate characteristics of the sound transferred from the mobile device to the earpiece coupling. The passive audio coupling may also be referred to as a passive audio channel, an audible channel, a folded horn, an air trumpet, and the like.

Earphone 5 and microphone 6 are connected to mobile phone jack 9 via mini plug 7. Mini plug 7 and jack 9, in this embodiment, are concentric 2.5 mm three conductor type. Positioning of earpiece 2 and mouthpiece 4 allow optimal sound quality by placing the earphone directly over the ear, while simultaneously placing the microphone as close as possible to the mouth. In alternative embodiments, electrical connections for earphone 5 and microphone 6 are made via, a connector (not shown) integrated with the slot 3 where the connector mates with the matching connector on the mobile phone 8 in order to establish the requisite electrical connections.

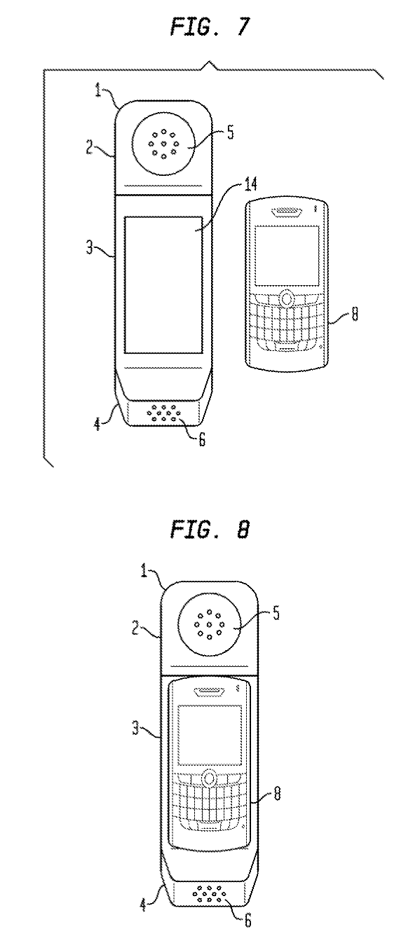

Referring to FIGS. 7, 8, 9, 10, another embodiment of dock 1 is constructed of hard plastic. Spring clips 13 or foam rubber hold mobile phone 8 in slot 3. Additionally, holster 14 may be provided as a means of securing mobile phone 8 to dock 1. Holster 14 may be constructed of fabric, elastic or solid material, providing access to controls and connections on the sides of mobile phone 8. Additionally, a hook and loop fastening system may be applied to the back of the mobile phone 8 and the slot 3 as an alternative fastening method. In another embodiment, the hard plastic is further coated selectively or entirely with an elastic shock absorbing material, such as foam rubber.

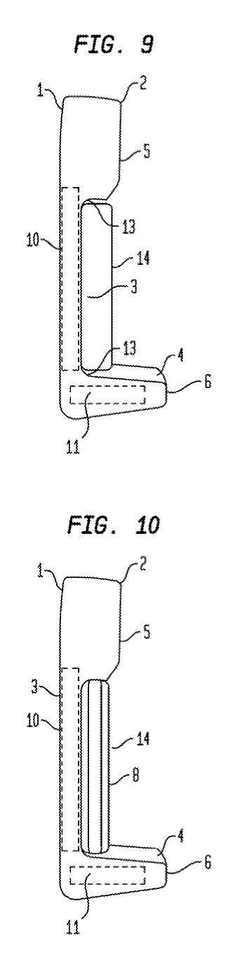

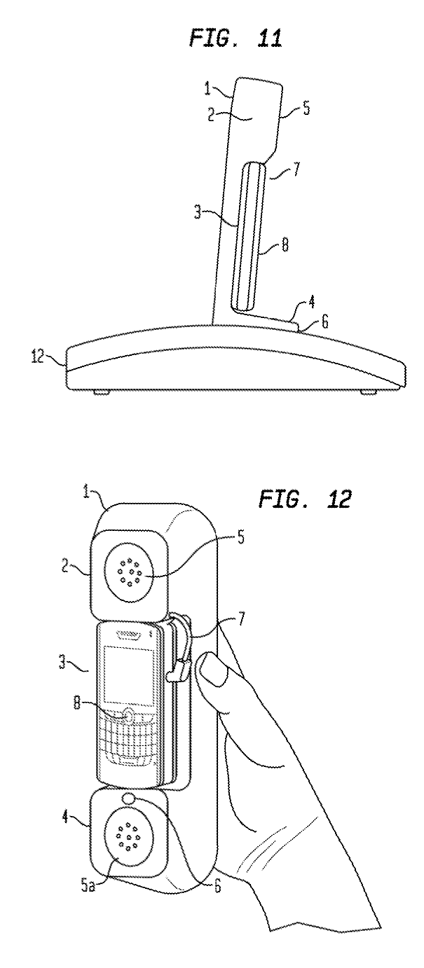

Referring to FIGS. 9 and 10, dock 1 contains optional rechargeable battery 10. Battery 10 is connected to mobile phone 8 charging jack. Charging jack and plug, in this embodiment, are polarized miniature USB type, in other embodiments, the charging jack is integral with the slot 3 and an electrical connection is established between the mobile phone 8 and the dock 1 when the mobile phone 8 is inserted into the slot 3. In one embodiment, a battery 10 provides auxiliary power to the mobile phone 8 while it is in the dock 1, and may be used to recharge mobile phone battery. Dock battery 10 may be recharged with charging base 12 when not in use (FIG. 11).

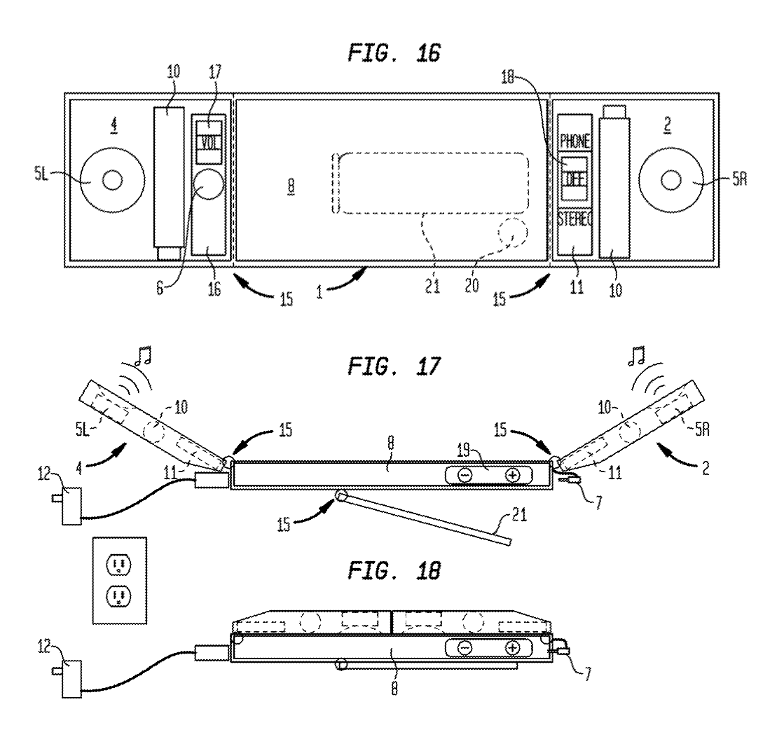

Referring to FIGS. 9 and 10, dock 1 contains optional audio amplifier 11. Amplifier 11 is powered by battery 10, and may be used to boost the volume of earphone 5 or microphone 6, or both. This feature allows the user to whisper or speak softly when necessary, of overcome extreme background noise, or aid those with hearing impairment. In this embodiment, the amplifier 10 and mobile phone 8 are equipped with Bluetooth circuitry, providing an optional wireless means of connecting, the dock, rather than mini plug 7. Additional circuitry may in other embodiments be added to amplifier 11 such as compression, noise reduction, active filtering and other effects, as well as multiple microphone noise cancellation processes as known in the art. In one instance the dock 1 further comprises multiple directional microphones for use in a multi-microphone noise cancellation system. In still another embodiment the dock 1 is used as a speakerphone, where both loudspeakers 5L and 5R (FIGS. 16 and 17) are used in conjunction with and substantially simultaneously with the microphone 6 providing a stereo playback configuration. In this manner, the dock 1 when opened and the speaker is turned on would operate as a speaker phone. In another embodiment, the user is able to continue to use another headset, such as a Bluetooth headset in conjunction with the dock to provide amplified sound while retaining the use of a microphone in the Bluetooth headset.

In certain additional embodiments, an optional retractable flap may be provided to cover the face of the mobile phone 8 when in use. This flap would help reduce electromagnetic radiation exposure by shielding the user and or may reduce errant entries caused by inadvertent contact with a touch screen display, for example. Flap may be constructed in whole or in part of shielding materials, including metals such as lead or aluminum, or plastic materials coated with a conductive coating, or conductive plastics (i.e. plastic with embedded conductive materials such as carbon nanotubes or carbon black). Flap may be rigid or a flexible metallic fabric or material. Flap may be secured by a hook and loop fastening system or other method to further secure and protect mobile phone. In another embodiments, the dock 1 uses the flap or other conductive structure(s) on the dock 1 to form a ground plane that improves the performance of the mobile phone 8 antenna. In another embodiment, at least one slot, earpiece, mouthpiece, earphone, and/or microphone form a ground plane that improves performance of the mobile phone 8 antenna. In still another embodiment for use with mobile phones 8 with a radio frequency (RF) port, the dock 1 further comprises an external antenna to provide enhanced. RF performance to the mobile phone 8.

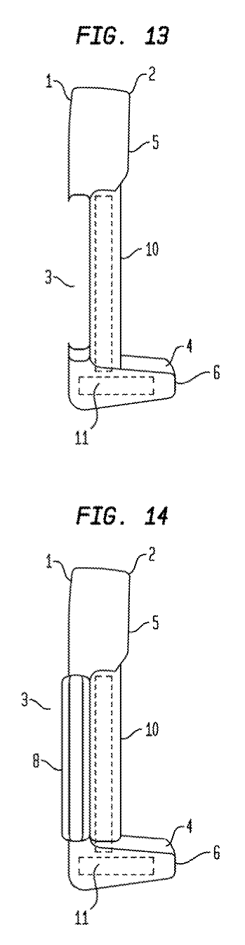

Referring to FIGS. 13 and 14, the orientation of mobile phone 8 and battery 10 is reversed. In this configuration, slot 3 is provided on the back or outside of dock 1 to accept mobile phone 8. Auxiliary battery 10 is mounted between mobile phone 8 and the user's head to further shield user from electromagnetic radiation. This configuration also moves mobile phone 8 farther away from the user when in use.

Many mobile phones, particularly ones that have large or touch screen displays, produce large amounts of heat. This can be uncomfortable to the user. The dock 1 helps to insulate the user from excessive heat. In another embodiment, the dock 1 further comprises a heat sink material to transmit heat away from the user. In still another embodiment, the outer surface of the dock 1 forms a radiator to spread the heat across a larger surface thus reducing the temperature of the surface.

Optional cover for the dock 1, made from leather, vinyl, plastic, fabric, or other material, may be provided to enhance feel and comfort and appearance. Cover may also be applied as a coating, or molded over the base material. Cover may be designed with different colors, logos, etc. to personalize the dock, or to promote social or business interests such as products, sports teams, musicians, cartoon characters, or movie stars.

The body of the dock 1 in some embodiments is optionally constructed of closed cell foam or other buoyant material, or contain air bladders to cause it to float. This will protect the mobile phone and dock from sinking in case it is dropped in water.

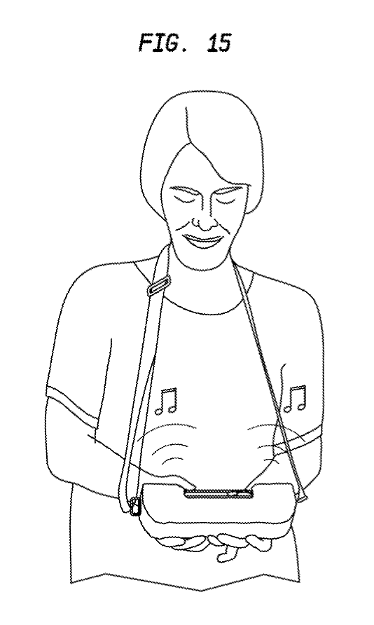

Some mobile phones contain music players or other programs such as video or games that output stereophonic sound. These phones are normally equipped with a four conductor 3.5 mm jack instead of 2.5 mm three conductor jack, to route the stereophonic sound to stereo headphones or ear buds. Referring to FIG. 12 and FIG. 15, mouthpiece 4 is fitted with additional earphone 5a. The two earphones 5 and 5a together provide stereophonic playback. This additional feature allows the dock 1 to serve as a portable stereophonic audio playback system. In this case, amplifier 11 is a stereo amplifier. Depending on the mobile telephone model, a switch may be provided to disconnect earphone 5a when the mobile phone is being used in monophonic telephone mode, to avoid feedback or echo caused by the close proximity of earphone 5a to microphone 6. In another embodiment, a three conductor jack having stereophonic sound transmission capability to be used in combination with a wireless device's microphone. In yet another embodiment, a four conductor jack having stereophonic sound transmission capability takes place of the wireless device's microphone.

Amenities such as straps, belt clips, identification tags, pockets, handles, shoulder rest, tote bag, may be provided as accessories or integrated into the basic design. (FIG. 15)

In another embodiment, referring to FIGS. 16, 17 and 18, earpiece 2 and mouthpiece 4 are attached to dock 1 with hinges 15 to form sound wings, in one embodiment the hinges 15 are pre-sprung to urge the earpiece 2 and mouthpiece 4 inward, toward the mobile phone 8. In another embodiment, dock 1 may only include earpiece 2 or mouthpiece 4. In the illustrated embodiments, a stop is provided to lock the earpiece 2 and mouthpiece 4 into the open position. When released, the sound wings snap into or swing to the closed position. In another embodiment, the spring hinges 15 are pre-sprung to urge the earpiece 2 and mouthpiece 4 away from the mobile phone 8. A stop is provided to lock, the earpiece 2 and mouthpiece 4 in the closed position (i.e. overtop the mobile phone 8). In still another embodiment, the hinges 15 are substantially unsprung and instead have detents, friction producing hinges or other mechanical locking, aspects that allow the earpiece 2 and mouthpiece 4 to be placed in a closed or locked position, an open position or other angles according, to user preference. In the embodiment depicted in FIGS. 16, 17 and 18, the protective cover formed over the mobile phone 8 is created by substantially abutting the edges of the earpiece 2 and the mouthpiece 4 as shown most clearly in FIG. 18. In another embodiment (not depicted), the earpiece 2 and the mouthpiece 4 overlap such that a portion of one part partially overlaps a portion of the second part.

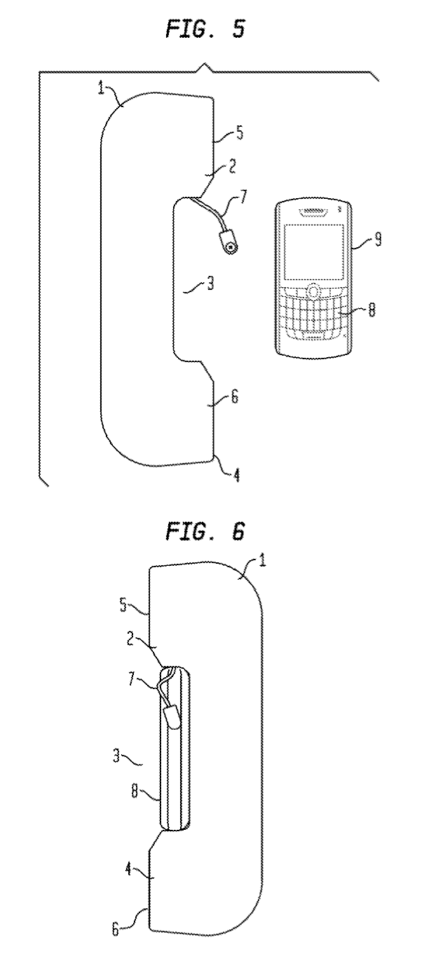

The configuration depicted in FIGS. 16, 17 and 18 forms a substantially closed protective case when closed (i.e. the mobile phone 8 is covered by the earpiece 2 and the mouthpiece 4) and a full size telephone handset when open. When describing the handset as a “full-size” handset, the intent is to describe at least two aspects, that are not necessarily limited or restricted. In one aspect, when used as a traditional phone—namely held to the ear and mouth—the microphone 6 for recording a user's voice is located closer to the user's mouth while at the same time the speaker 5R in the embodiment depicted is located, closer to the user's ear. In this manner, when the microphone 6 and the speaker 5R are closer to the user's mouth and ear, respectively, it is referred to as “full-size.” In another aspect, the full size aspect of the device may also refer to the thickness of the device as shown, for example, in at least the embodiments of FIGS. 5 and 6. In another aspect the term full-size can refer to both the length and thickness of the device.

Mobile phone 8 may be charged with power supply 12 when in open or closed position. Cutouts are provided in dock 1 to gain access to controls and connections such as volume controls 19 and camera 20, as well as power supply and headset connections. Batteries 10 supply power to amplifier 11 and microphone preamplifier 16.

In one embodiment, the battery(ies) 10 are sized to provide additional supplemental charging capacity to the mobile phone 8 for use extending the battery life of the mobile phone 8. In another embodiment, the dock 1 is adapted to use power from the mobile phone 8, via an accessory port for example, to power the dock 1 electronics. In still another embodiment, the dock 1 scavenges power from the power supply 12 in parallel with the mobile phone 8 thus allowing the battery(ies) 10 in the dock 1 to be simultaneously charged in tandem with the mobile phone 8, in one aspect, the dock 1 monitors the current drain on the power supply 12 and only charges the battery(ies) 10 when the power draw for the mobile phone 8 drops below a specific threshold. For example, if the mobile phone 8 is drawing above the specific threshold while charging, the dock 1 will not charge its batters 10, then when the mobile phone 8 draw is below the certain threshold, the dock 1 will proceed to draw power in tandem to recharge the battery(ies) 10. In another embodiment, the batteries may be at least one of the following: non-rechargeable and/or rechargeable.

Three position switch 18 is provided to switch between different operation modes. In STEREO mode, sound from the mobile phone 8 is routed through the stereo amplifier 11 and output through loudspeakers 5L and 5R. In one aspect, if the mobile phone 8 is incapable of outputting, stereo sound, the loudspeakers 5L and 5R output monoaural sound through both speakers, i.e. both speakers 5L and 5R are feed from a single or common signal path.

In PHONE mode, loudspeaker 5L is disconnected, and mono sound from mobile phone 8 is routed first through equalizer contained in microphone preamplifier 16, and then to loudspeaker 5R through amplifier 11. Also in PHONE mode, microphone 6 is routed to loudspeaker 5R through amplifier 11, as well as to the mobile phone microphone jack for outgoing transmission. In one embodiment, a combining network is provided in preamplifier 16, the combining network is used to route sound from the microphone 6 to the loudspeaker 5R. In an aspect, a potentiometer 17 is provided to balance the signal from the microphone 6 and the mobile phone 8 prior to amplification and broadcast by the loudspeaker 5R. In still another embodiment, the combining network present in preamplifier 16 selectively attenuates the signal from either the loudspeaker 5R or the microphone 6 depending on relative signal to noise ratios, thereby focusing the listener's attention on the primary signal, in other words, when the user is speaking, the high signal to noise ratio from the microphone 6 would result in an attenuation of the mobile phone 8 signal, thereby reducing noise or other background sounds present in the mobile phone 8 signal. In this aspect the potentiometer 17 is used to adjust the attenuation rate of the combining network.

In other embodiments, separate equalizers are used to process signals for any or all of the following signals destined for the loudspeakers 5R and/or 5L originating from: a) microphone 6; b) the mobile phone 8 voice signal; and c) the mobile phone 8 stereo signal. In the various embodiments, the separate equalizers can be either active or passive or a combination of both. In further embodiments, an equalizer is applied, to a transmission received from pickups on the device and sent to the phone such as the signal from the microphone 6 to the mobile phone 8 as an audio input. In a similar manner, in addition to separate equalizer sections, separate amplifiers and pre-amplifier circuits are used in other embodiments to process the various signals present in the dock 1. In one aspect, the equalizer(s) are implemented via digital signal processing and a logic chip, including without limitation a digital signal processing (DSP) chip, and application specific integrated circuit (ASIC) and/or a logical gate array.

In another embodiment, the equalizer section contours the sound to produce a more pleasing frequency response during mobile phone application. In one aspect the equalizer section includes an active noise compensating system, boosting portions of the signal most commonly used for speech while attenuating those bands where noise occurs. In another aspect, the equalizer section further includes an additional amplifier that increases the signal strength associated with the high frequency portion of the signal spectrum, in one aspect the high frequency portion of the signal is greater than or equal to 6-8 kHz. In another aspect, the equalizer is used to increase the signal strength of low-frequency signals present in the incoming signal prior to reaching the loudspeaker(s) 5L and 5R. In still another aspect, the equalizer attenuates the mid-frequency ranges of the signal and increases the lower and high frequency (limited to the speech bands) to create a more level sound. In other embodiments, digital signal processing is used to perform the function of the equalizer in order to generate more audibly pleasing and/or recognizable sounds.

Covering of the dock 1 ma be constructed of leather or fabric or other hard or soft synthetic material. Hinges 15 may be formed of rigid material such as metal or flexible material such as fabric. Shoulder rest 21 is fastened to dock 1 with spring, hinge 15. Shoulder rest 21 locks into the open position, and returns to the closed position when released. Shoulder rest 21 can also function as a belt clip. In another configuration, spring hinges 15 may be installed in reverse, where the springs cause the earpiece 2 and mouthpiece 4 to spring, open rather than closed when released. In this case, a spring or magnetic catch or zippers are provided to maintain dock in the closed position. En another aspect, this embodiment may be resized to accommodate other devices such as tablet computers or music players.

It is to be clearly understood that the above description is intended by way of illustration and example only and is not intended to be taken by way of limitation, and that changes and modifications are possible. Accordingly, other embodiments are contemplated and modifications and changes could be made without departing from the scope of this application.

I claim:

1. A mobile phone docking system comprising:
a mobile dock adapted to be held to an ear and having a slot adapted to receive the mobile phone; and
a means for releasably holding the mobile phone in said mobile dock.

2. The mobile phone docking system of claim 1, wherein said mobile dock is constructed of a compressible material.

3. The mobile phone docking system of claim 1, further comprising:
a retractable flap, wherein a first edge of said retractable flap is hingedly secured to said mobile dock and a second edge of said retractable flap is secured to said mobile dock by a means for securably fastening, wherein said flap is constructed in part or in whole of shielding materials.

4. The mobile phone docking system of claim 3, wherein said retractable flap forms a ground plane with respect to an antenna of the mobile phone.

5. The mobile phone docking system of claim 1, wherein said mobile dock further comprises;
a passive audio port operably coupled to a passive audible coupling that couples a cup to the mobile phone.

6. The mobile phone docking system of claim 1, further comprising:
a means for connecting a data signal between the mobile phone and said mobile dock;
and
a first earpiece housed in said mobile dock, located at a top end of said mobile dock and adapted to communicate with the mobile phone, wherein said first earpiece improves sound quality.

7. The mobile phone docking system of claim 1, further comprising a microphone housed in said mobile dock, located at a bottom end of said mobile dock and adapted to communicate with the mobile phone.

8. The mobile phone docking system of claim 7, further comprising:
said mobile dock comprising an audio amplifier external to the mobile phone.

9. The mobile phone docking system of claim 8, wherein said audio amplifier comprises active filtering of said audio signal.

10. The mobile phone docking system of claim 6, further comprising:
a plurality of multi-directional microphones providing a plurality of different input signals; and
a noise cancellation circuitry, using said plurality of different input signals to cancel noise and adapted to output an audio signal to the mobile phone.

11. The mobile phone docking system of claim 6, further comprising:
a second earpiece located at said bottom end of said mobile dock, wherein said second earpiece in combination with said first earpiece provide for a stereophonic playback; and
a switch which disconnects said data signal from reaching said second earpiece when the mobile phone is in a monophonic telephone mode.

12. The mobile phone docking system of claim 1, wherein said mobile dock has a front face and a back face, wherein the mobile phone is received by said mobile dock on said back face, and wherein a loud speaker is disposed on said from face.

13. The mobile phone docking system of claim 1, further comprising a battery, wherein said battery has a location selected from the group consisting of between said front and said back, between the mobile phone and said front, and between the mobile phone and said back.

14. The mobile phone docking system of claim 1, further comprising:
a heat sink adapted to be thermally coupled to the mobile phone.

15. A mobile device docking system comprising:
a mobile dock having a receptacle adapted to receive the mobile device and a first end and a second end;
a first wing rotably coupled to said first end with a first closed position wherein said first wing faces said receptacle and a second open position wherein said first wing is disposed adjacent said receptacle; and
said first wing further comprising a speaker and a battery, said speaker adapted to receive and broadcast an audible signal emitted by the mobile device.

16. The mobile device docking system of claim 15 further comprising a second wing rotably coupled to said second end with a first closed position wherein said second wing faces said receptacle and a second open position wherein said second wing is disposed adjacent said receptacle adapted such that said first wing in said closed position and said second wing in said closed position are disposed adjacent to each other; said second wing further comprising a speaker, a battery and a microphone, and wherein said microphone is configured to electronically couple to the mobile device.

17. The mobile device docking system of claim 15, wherein said first wing and said second wing are each connected to said dock by a spring loaded hinge adapted to urge said wings in a first direction.

18. The mobile device docking system of claim 16, further comprising:
a means for selectively activating said microphone in response to the mobile device.

19. The mobile device docking system of claim 15, wherein said audible signal from said microphone is electrically coupled to said first speaker.

20. The mobile device docking system of claim 15, further comprising:
a shoulder rest hingedly connected to a back face of said dock.
